(19) United States
(12) Patent Application Publication
(10) Pub. No.: US 2022/0160567 A1
(43) Pub. Date: May 26, 2022

(54) TABLE PAD AND FLUID COLLECTION COVER THEREFOR AND METHOD OF PROTECTING A TABLE PAD AND SURROUNDINGS AGAINST FLUID CONTAMINATION

(71) Applicant: Domico Med-Device, LLC., Fenton, MI (US)

(72) Inventors: Michael W. Czop, Fenton, MI (US); Samba Toure, Grand Blanc, MI (US)

(21) Appl. No.: 17/533,989

(22) Filed: Nov. 23, 2021

Related U.S. Application Data
(60) Provisional application No. 63/117,218, filed on Nov. 23, 2020.

(51) Int. Cl. A61G 13/10

(52) U.S. Cl. CPC A61G 13/102

(57) ABSTRACT

A cover configured to protect a compliant pad on a patient support surface of a patient table to prevent contamination from contacting the compliant pad, the patient support surface, and an area surrounding the patient support surface is provided. The cover has a flexible upper wall with opposite sides extending lengthwise between opposite ends. A fluid collection funnel extends from one of the opposite ends. At least one fixation member extends adjacent at least one of the opposite ends, with the fixation member being configured to releasably fix the flexible upper wall to at least one of the compliant pad and the patient support surface.

### CROSS-REFERENCE TO RELATED APPLICATION

This application claims the benefit of U.S. Provisional Application Ser. No. 63/117,218, filed Nov. 23, 2020, which is incorporated herein by reference in its entirety.

### BACKGROUND

### 1. Technical Field

This invention relates generally to patient support surfaces, such as patient support tables, and compliant pads therefor, and more particularly to patient support surface compliant pads and protective covers therefor for protecting the compliant pad and surroundings against fluid contamination from a patient resting on the patient support table.

### 2. Related Art

The need to provide and maintain a clean, contamination free, and often sterile environment in a medical arena is well established. Contamination, such as from patient fluids, including blood and urine, for example, is directly associated with the known risk of infection that can be caused by bacteria from such contamination in the medical arena. As such, it is known that in order to minimize the risk of infection during a medical procedure, it is necessary to prevent the transfer of bacteria via contamination within the medical arena. Although the risks of infection during medical procedures are recognized, it remains a challenge to prevent the onset thereof, particularly with the challenges faced in preventing the contamination of surfaces, including patient support surfaces (table tops of patient support tables, including surgical tables and tables used in various forms of medical procedures, such as a urological procedure, for example) and compliant patient support pads thereon by patient fluids, such as blood and/or urine. Infections are estimated to affect upwards of 2 million patients or more annually. Aside from the complications brought about by infections, the infections create an economic burden on hospitals. For example, some studies have estimated that each bloodstream infection in a patient results in an average cost of $26,839 to the hospital. Accordingly, advances are needed to reduce the potential of contamination within the medical arena and infection resulting therefrom.

There is no single accepted methodology for covering table surfaces and/or compliant patient support pads thereon to protect against contamination, but most often flat sheets of plastic, known as “half sheets,” are simply draped over the surface to be protected. Of course, if the half sheets are not properly deployed, then the sterility of the underlying surface and medical arena is compromised, and thus, the potential for onset of infection in the patient increases. Further, if the surface on which the patient is lying is moved, even if the surface is initially draped properly, there remains an associated risk that the current draping mechanisms will become displaced, thereby exposing surroundings against contamination. Further yet, even if the current draping remains in place, there remains a risk that contaminants, such as blood and/or urine, can freely fall or flow onto and over an edge of the support surface onto an underlying, unprotected surface. Accordingly, a need exists for an improved protective drape and method of establishing and maintaining sterility in a medical arena, particularly for use with patient support surfaces and compliant patient support pads therefor.

### SUMMARY OF THE INVENTION

A cover configured to protect a compliant pad on a patient support surface to prevent contamination from contacting the compliant pad, the patient support surface, and an area surrounding the patient support surface, is provided. The cover has a flexible upper wall with opposite sides extending lengthwise between opposite ends. At least one fluid collection funnel extends from at least one of the opposite ends. At least one fixation member extends adjacent at least one of the opposite ends, with the fixation member being configured to releasably fix the flexible upper wall to at least one of the compliant pad and the patient support surface.

In accordance with another aspect of the disclosure, the at least one fixation member can be formed from the same type of material as the flexible upper wall.

In accordance with another aspect of the disclosure, the at least one fixation member can include a bottom wall fixed to the upper wall, with the bottom wall and the upper wall forming a pocket having an opening sized for receipt of an end of the compliant pad into the pocket.

In accordance with another aspect of the disclosure, the bottom wall of the fixation member can be provided having a plurality of openings configured to facilitate attachment of the compliant pad directly to the patient support surface.

In accordance with another aspect of the disclosure, the at least one fluid collection funnel can be formed from the same type of material as the flexible upper wall, thereby simplifying and rendering the manufacture of the cover economical.

In accordance with another aspect of the disclosure, the at least one fluid collection funnel can include a pair of fluid collection funnels, with one of the pair of fluid collection funnels extending from one of the opposite ends and the other of the pair of fluid collection funnels extending from the other of the opposite ends, thereby assuring the containment of fluid and preventing contaminating of the surroundings of the patient support surface along opposite ends of the patient support surface, particularly if the patient support surface is tilted both fore and aft during a medical procedure.

In accordance with another aspect of the disclosure, the pair of fluid collection funnels can be formed from the same type of material as the flexible upper wall, thereby simplifying and rendering the manufacture of the cover economical.

In accordance with another aspect of the disclosure, the cover can further include a fluid collection channel extending along each of the opposite sides, with the fluid collection channels being configured to channel fluid to the at least one fluid collection funnel, thereby preventing fluid from flowing beyond the opposite sides of the cover onto a surface surrounding the patient support surface.

In accordance with another aspect of the disclosure, the fluid collection channels can be configured to extend in fluid communication with both of the pair of fluid collection funnels.

In accordance with another aspect of the disclosure, the pair of fluid collection funnels can be formed from the same type of material as the flexible upper wall, thereby simplifying and rendering the manufacture of the cover economical.

In accordance with another aspect of the disclosure, the pair of fluid collection funnels can be formed as a monolithic piece of material with the flexible upper wall, thereby further simplifying and rendering the manufacture of the cover economical.

In accordance with another aspect of the disclosure, each of the pair of fluid collection funnels can be provided to extend from a proximal end, fixed to the flexible upper wall, to a free distal end, with at least one of the pair of fluid collection funnels being configured to channel fluid to a drain tube coupled to the distal end of the at least one fluid collection funnel. Accordingly, the at least one fluid collection funnel having the drain tube coupled thereto does not need to be sized to contain all the fluid flowing therein, as the fluid is free to flow in a controlled manner through the drain tube to a desired location, such as a fluid basin.

In accordance with another aspect of the disclosure, a filter member can be disposed between the proximal end and the free distal end of the at least one fluid collection funnel, with the filter member being configured to allow the flow of fluid therethrough and to inhibit the flow of solid matter therethrough. Accordingly, the filtering out of solid contaminant can prevent the clogging of a downstream drain tube, if provided, and can further allow the accurate measurement of only fluid drained through the at least one fluid collection funnel, if desired.

In accordance with another aspect of the disclosure, a biasing member operable to maintain the at least one fluid collection funnel in an open state to receive fluid therein can be provided.

In accordance with another aspect of the disclosure, the biasing member can be provided as a malleable piece of material.

In accordance with another aspect of the disclosure, the at least one fluid collection funnel can include a fixation member extending along the proximal end, with the fixation member being configured to releasably fix the proximal end to a funnel support member on the patient support surface and to maintain the proximal end in an open state to receive fluid therein.

In accordance with another aspect of the disclosure, the fixation member can be formed from the same type of material as the flexible upper wall, thereby simplifying and rendering the manufacture of the cover economical.

In accordance with another aspect of the disclosure, the fixation member can be formed as a monolithic piece of material with the flexible upper wall, thereby further simplifying and rendering the manufacture of the cover economical.

In accordance with another aspect of the disclosure, the at least one fluid collection funnel can be provided to extend from one of the opposite ends and the least one fixation member can be provided to extend adjacent the other of the opposite ends.

In accordance with another aspect of the disclosure, a side flap can be provided to extend along and outwardly from each of the opposite sides, with the side flaps being configured to extend along opposite sides of the patient support surface.

In accordance with another aspect of the disclosure, a fluid barrier can be provided to extend between the upper wall and each of the side flaps, with the fluid barriers extending upwardly from the upper wall and being configured to channel fluid toward the at least one fluid collection funnel.

In accordance with another aspect of the disclosure, a method of protecting a compliant pad on a patient support surface and surroundings of the patient support surface against fluid contamination is provided. The method includes: providing a flexible upper wall having opposite sides extending lengthwise between opposite ends and having a fluid collection funnel extending from at least one of the opposite ends and at least one fixation member extending adjacent at least one of the opposite ends. Further, releasably fixing the flexible upper wall to the compliant pad with the at least one fixation member; and, allowing the at least one fluid collection funnel to hang over an edge of the patient support surface to facilitate fluid flowing on the flexible upper wall to flow into the fluid collection funnel.

In accordance with another aspect of the disclosure, the method can further include providing the at least one fixation member having a bottom wall fixed to the upper wall, with the bottom wall and the upper wall forming a pocket having an opening, and releasably fixing the flexible upper wall to the compliant pad by disposing an end of the compliant pad into the pocket.

In accordance with another aspect of the disclosure, the method can further include fixing a proximal end of the at least one fluid collection funnel to the upper wall and coupling a drain tube to a distal end of at least one of the at least one fluid collection funnel.

In accordance with another aspect of the disclosure, the method can further include providing the at least one fluid collection funnel being formed from the same type of material as the flexible upper wall.

In accordance with another aspect of the disclosure, the method can further include providing the at least one fluid collection funnel as a pair of fluid collection funnels, with one of the pair of fluid collection funnels extending from one of the opposite ends and the other of the pair of fluid collection funnels extending from the other of the opposite ends.

In accordance with another aspect of the disclosure, the method can further include providing a fluid collection channel extending along each of the opposite sides of the upper wall and configuring the fluid collection channels to channel fluid to the at least one fluid collection funnel.

In accordance with another aspect of the disclosure, the method can further include configuring the fluid collection channels to channel fluid to fluid collection funnels extending from each of the opposite ends of the upper wall.

### BRIEF DESCRIPTION OF THE DRAWINGS

These and other aspects, features and advantages of the invention will become more readily appreciated when considered in connection with the following detailed description of presently preferred embodiments and best mode, appended claims and accompanying drawings, in which:

FIG. 1 illustrates a perspective view of a patient support surface of a patient table with a cover constructed in accordance with one aspect of the disclosure disposed over a patient support pad on the patient support surface, wherein a patient is positioned on top of the cover and patient support pad during a medical procedure;

FIG. 1A is a view similar to FIG. 1 illustrating the cover in a folded, pre-assembled state resting on the patient support pad disposed on the patient support surface of the patient table;

FIG. 2 illustrates a top view of the cover of FIG. 1;

FIG. 3 illustrates a bottom view of the cover of FIG. 1;

FIG. 4 illustrates a top plan view of a compliant table pad;

FIG. 5 illustrates a bottom plan view of the compliant table pad of FIG. 4;

FIG. 6 is a view similar to FIG. 3 with the compliant table pad shown protected by the cover;

FIG. 7 illustrates a top plan view of the cover and compliant table pad of FIG. 6;

FIG. 8 illustrates a bottom plan view of a compliant table pad shown protected by a cover constructed in accordance with another aspect of the disclosure;

FIG. 9 illustrates a top plan view of the cover and compliant table pad of FIG. 8;

FIG. 10 is a fragmentary perspective view taken generally about the circle 10 of FIG. 1 illustrating the cover pushed to an inner side of an accessory housing receptacle of the patient table in accordance with one aspect of the disclosure;

FIG. 11 is a view similar to FIG. 10 illustrating a sleeve of a cover constructed in accordance with another aspect of the disclosure disposed over the accessory housing receptacle of the patient table;

FIG. 12A is a view similar to FIG. 10 illustrating a flap flipped open to expose an opening of a cover constructed in accordance with another aspect of the disclosure, with the opening providing access to the accessory housing receptacle of the patient table; and

FIG. 12B is a view similar to FIG. 12A illustrating a flap flipped closed to cover the opening of a cover to shield the accessory housing receptacle of the patient table.

### DETAILED DESCRIPTION OF PRESENTLY PREFERRED EMBODIMENTS

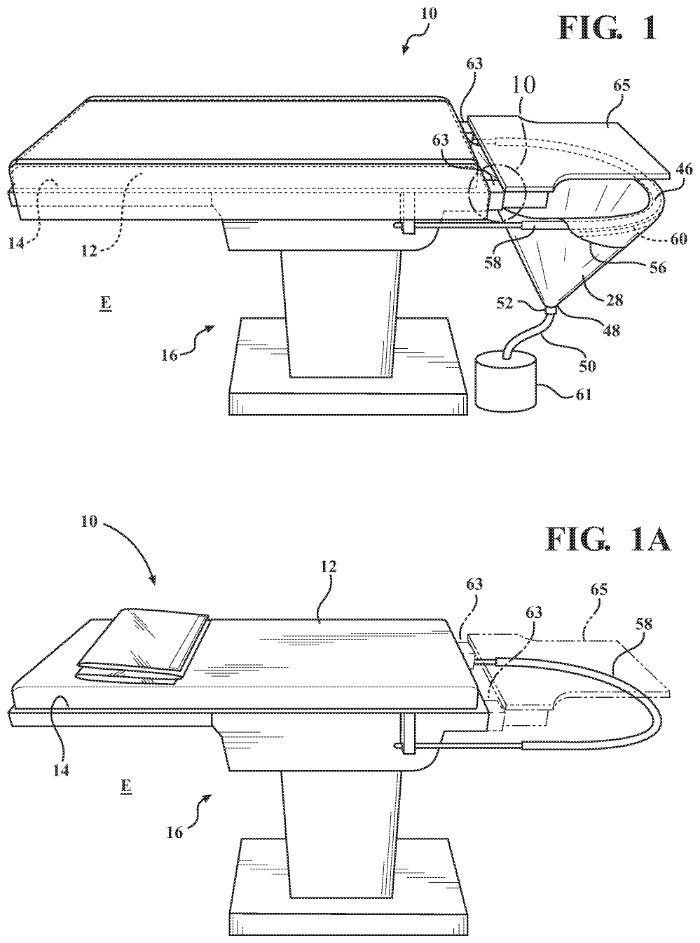

Referring in more detail to the drawings, FIG. 1 illustrates a patient support surface drape, also referred to as drape, patient support surface cover, or simply cover 10, constructed in accordance with one aspect of the disclosure, in use. The cover 10 is configured to cover and protect a compliant pad or cushion, also referred to as patient support pad or table pad 12, and patient support surface 14, such as on a patient table 16 and surroundings of the patient table 16, also referred to as environment E, against fluid contamination. Accordingly, the cover 10 prevents contamination from contacting the table pad 12, the patient support surface 14 and the environment E area immediately adjacent and surrounding the patient table 16. The patient table 16 can be provided as any number to types of patient support tables, including, but not limited to, a surgical/examination table, such as used in a surgical/examination medical arena, such as used during a urological or pelvic procedure, a gurney used to transport a patient, or the like.

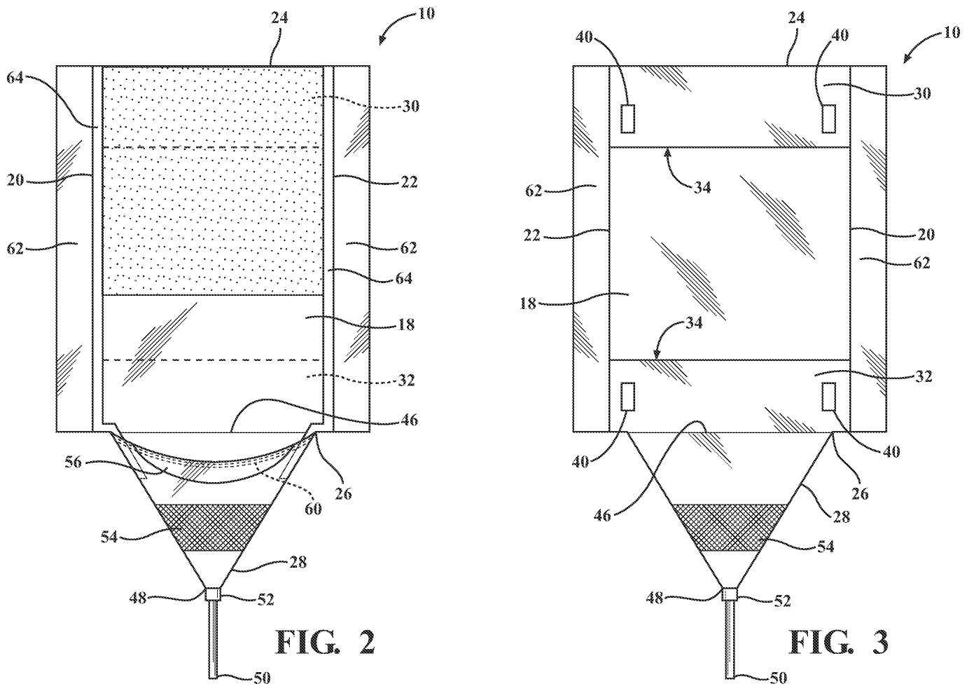

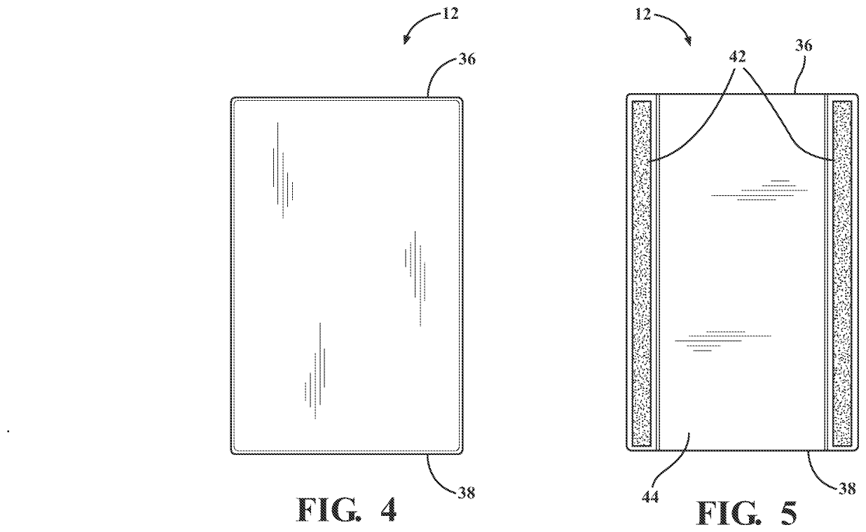

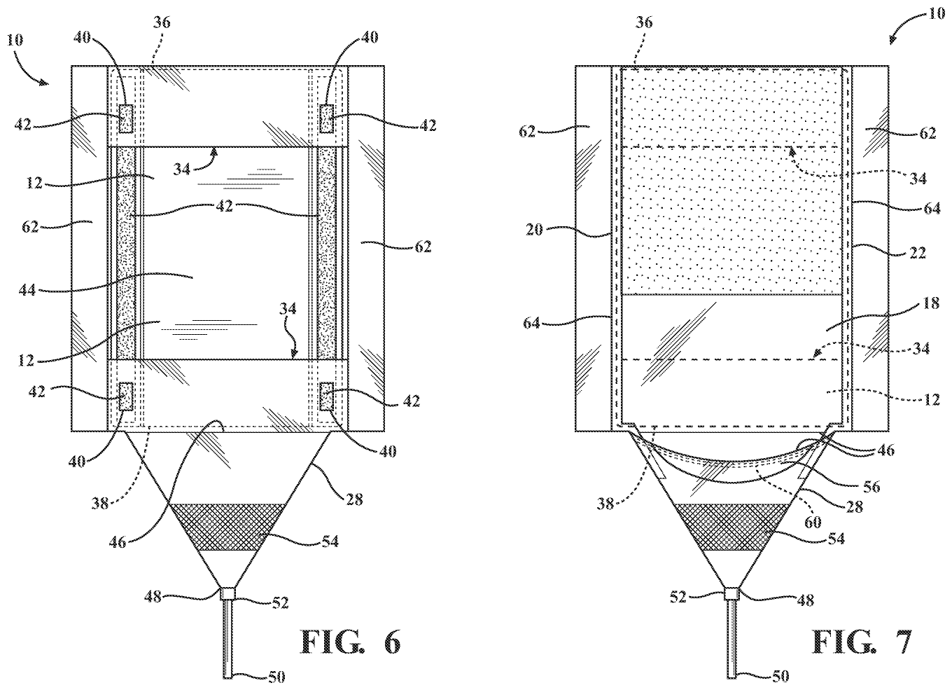

As best shown in FIGS. 2 and 3, the cover 10 has a flexible upper wall 18 with opposite sides 20, 22 extending lengthwise between opposite ends, with one end being referred to as a proximal or first end 24, and the other end being referred to as a distal end or second end 26. It is to be understood the use of the terms proximal and distal are for sake of identification purposes only, and are used herein consistently to identify the associated first and second ends 24, 26. A fluid collection funnel 28 extends from at least one of the ends, shown as extending from the second end 26, and at least one fixation member extends adjacent at least one of the ends, shown as a pair of fixation members 30, 32 extending adjacent both of the ends 24, 26. The fixation members 30, 32 are configured to releasably fix the flexible upper wall 18 to at least one of the compliant pad 12 and the patient support surface 14, and are shown as fixing the flexible upper wall 18 directly to the compliant pad 12 (FIGS. 6 and 7).

The fixation members 30, 32 are fixed to the wall 18, and can be formed of the same material as the upper wall 18, and further yet, can be formed as a monolithic piece of material with the upper wall 18, if desired, or formed as separate pieces of the same material and subsequently fixed to the upper wall 18, such as via a weld seam, adhesive, tape, or the like. Each fixation member 30, 32 is configured to releasably fix the upper wall 18 directly to the table pad 12 and operably, or directly if desired, to the patient support surface 14 of the patient table 16, as discussed further below, to prevent inadvertent movement of the upper wall 18 relative to the patient support surface 14 during use. Operable connection of the cover 10 to the patient table 16 can be provided by the compliant table pad 12 being fixed directly to the patient table 16, and via the cover 10 being fixed directly to the table pad 12.

As best shown in FIGS. 3 and 6, the at least one, and shown as pair of fixation members 30, 32 can be formed to extend along the opposite ends 24, 26. The fixation members 30, 32 can be formed of the same material as used for the upper wall 18, and are shown, by way of example and without limitation, as being formed as a monolithic piece of material (the same, single piece of material) with flexible wall 18, with the material being folded over itself and fixed, such as in a heat staking process or via an adhesive, by way of example and without limitation. As such, manufacture of the cover 10 is made economical by not having to cut and attach separate pieces of material to one another to form the fixation members 30, 32, though, fixation of separate pieces of material to form the fixation members 30, 32 is contemplated herein. The fixation members 30, 32 form open cuffs, also referred to as pockets 34, adjacent each of the opposite ends 24, 26. The pockets 34 have an opening sized for receipt of opposite ends 36, 38 of the table pad 12 therein, such that upon bending or folding opposite ends 36, 38 of the table pad 12, and then disposing the opposite ends 36, 38 into the pockets 34, the cover 10 is releasably fixed against sliding removal from the table pad 12. In order to remove the cover 10, the table pad 12 must again be folded to the allow the ends 36, 38 to be removed from the pockets 34. Other than the openings extending into the pockets 34, the outer periphery spanning two sides and a base of the pockets 34, extending from the opening, can be sealed closed. Accordingly, with the ends of the table pad 12 disposed into the pockets 34, a patient can sit or lie on the cover 10 with assurance that the cover 10 will remain in place, thereby assuring the protective aspects of the cover 10 discussed herein are provided as desired.

As shown in FIGS. 3 and 6, each of the folded and bonded flaps forming the pockets 34 can be provided having at least one through opening 40 to allow a fastener, such as a first fastener portion 42 (FIGS. 5 and 6), on an underside, also referred to as lower surface 44, of the table pad 12 to be attached directly to the patient support surface 14 of the patient table 16, thereby assuring the table pad 12 remains releasably fixed against sliding movement relative to the patient table 16. The first fastener portion 42 can be provided as one portion of a hook and loop type fastener, while a second fastener portion (not shown) can be provided and fixed to the patient support surface 14 of the patient table 16. Otherwise, the first fastener portion 42 could be provided as any other type of fastener, such as a portion of a snap-type fastener, self-adhesive strip or the like, by way of example and without limitation.

The fluid collection funnel 28 extends from a proximal end 46, fixed to the flexible upper wall 18, to a free distal end 48. The fluid collection funnel 28 is configured to contain and channel fluid in a controlled manner to avoid contamination of the surrounding environment E. In one exemplary embodiment, the fluid collection funnel 28 is configured to channel fluid to a drain tube 50 coupled to the distal end 48, such as via any suitable tube connector 52, which can be fixed to the distal end 48, such as via an adhesive, weld joint, tape, or otherwise, if desired. The fluid collection funnel 28 can be formed of the same material as used for the upper wall 18, including, by way of example and without limitation, as being formed as a monolithic piece of material with flexible wall 18. Otherwise, if not formed as a monolithic piece of material with the upper wall 18, the fluid collection funnel 28 can be fixed along a portion of the proximal end 46 to the second end 26 of the upper wall, such as via an adhesive, weld joint, tape, or otherwise, as desired.

The fluid collection funnel 28 can include an integral (contained in) fluid filter member 54. The filter member 54 can be disposed between the proximal end 46 and the free distal end 48, wherein the filter member 54 is configured to allow the free flow of fluid therethrough and to inhibit the flow of solid, particulate matter therethrough or thereby. Accordingly, any solid particulate flowing into the fluid collection funnel 28 can be contained therein, thereby preventing the solid particulate from causing a clog downstream, such as in the drain tube 50, while also allowing only the fluid to be collected downstream, if desired. This allows the volume of fluid to be measured, such as in a collection basin 61, if desired, to ensure an expected amount of fluid is accounted for, as will be understood by a person possessing ordinary skill in the art (POSA). The filter member 54 can be provided of any desired filtrate medium, depending on the level of filtering desired. An outer periphery of the filter member 54 can be fixed about an inner, circumferential periphery of the fluid collection funnel 28 via any suitable fixation mechanism, including an adhesive, weld joint, tape, or otherwise, with the filter member 54 extending across the fluid collection funnel 28. The filter member 54 could be provided as the same type of material as the fluid collection funnel 28 and/or upper wall 18, such as a flexible sheet of plastic having slits formed therein to allow the flow of fluid through the slits, while obstructing the flow of solid particulate therethrough, by way of example and without limitation.

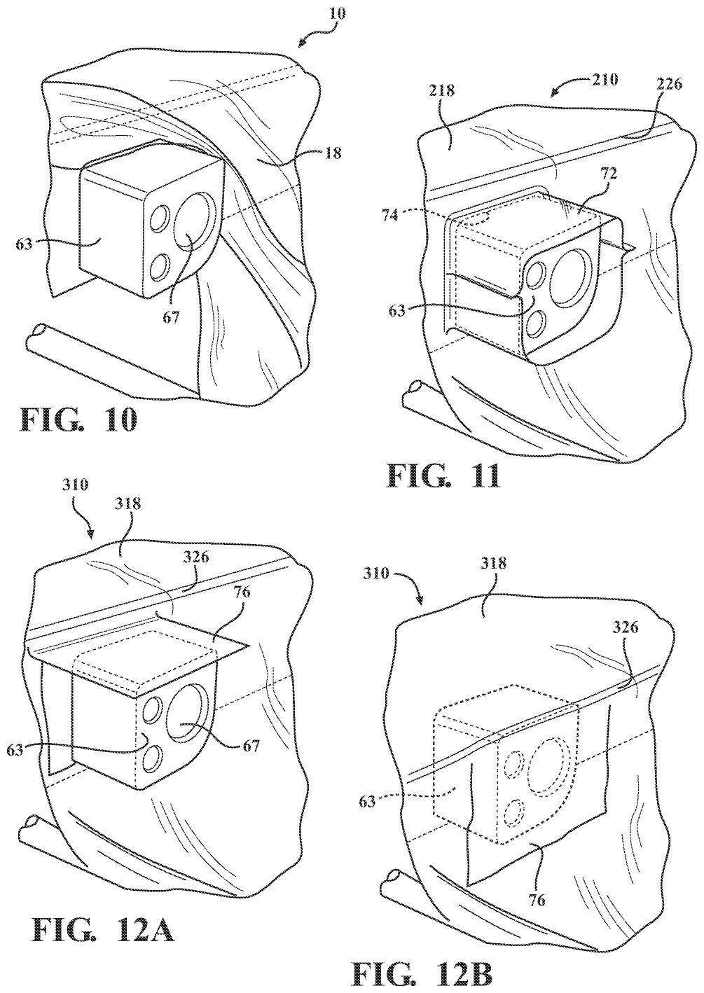

The fluid collection funnel 28 includes a fixation member 56 (FIGS. 2 and 7) extending along the proximal end 46. The fixation member 56 is configured to releasably fix the proximal end 46 to a funnel support member 58 (FIGS. 1 and 1A) extending from the patient support surface 14 and to maintain the proximal end 46 in an open state to receive fluid therein. The funnel support member 58 can be formed from a rigid or semi-rigid piece of material, such as a metal grade plastic or metal material, including a stainless steel strip or band, by way of example and without limitation. The fixation member 56 can be formed from the same type of material as the fluid collection funnel 28, and can be formed as a monolithic piece of material with the fluid collection funnel 28, such as by being formed from a fold flap, also referred to as cuff, of the material forming the fluid collection funnel 28. The fixation member 56 can simply be draped or looped over the funnel support member 58 to support the fluid collection funnel 28 in its desired position. Either during or after hanging the fixation member 56 on the funnel support member 58, the cover wall 18 can be gathered inwardly of an accessory support housing 63 extending from each side of the patient table 16, such as shown in FIG. 10. The accessory support housing 63 is commonly used to releasably support an accessory, such as a leg extension 65 (FIG. 1), upon which the patient can place their legs during a procedure. Accordingly, by tucking the cover 10 inwardly of the accessory support housings 63, receptacles 67 of the accessory support housing 63 remain fully accessible for receipt of attachment portions of the leg extension 65.

To further enhance maintaining the fluid collection funnel 28 in its desired open state, a biasing member 60 (FIG. 7) can be fixed along at least a portion of the proximal end 46, wherein the biasing member 60 can be provided as a formable, plastically deformable, malleable member to render the proximal end 46 as being plastically formable by hand. Accordingly, the proximal end 46 can be shaped as desired. Further, the biasing member 60 can be provided having a predetermined memory shape, such that when externally applied handling forces are release, the biasing member 60 retains its predetermined memory shape, such as is commonly performed via Nitinol, for example.

As best shown in FIGS. 2 and 7, the cover 10 can further include a side flap 62 extending along and outwardly from each of the opposite sides 20, 22. The side flaps 62 can be configured to extend along and beyond opposite sides of the patient support surface 14. A fluid barrier 64 can be provided to extend lengthwise along a length of the cover 10 from the first end 24 to the second end 26 along the opposite sides 20, 22 adjacent the side flaps 62. The fluid barriers 64 can be formed as upstanding ribs of any desired material, including from gathered material of the cover 10 itself, to extend upwardly from the upper wall 18 to act as a dam or an obstruction to the flow of fluid, with the fluid barriers 64 being configured to channel fluid toward the fluid collection funnel 28. As such, fluid is prevented from flowing over the opposite sides 20, 22 and beyond the patient support surface 14 onto a ground surface.

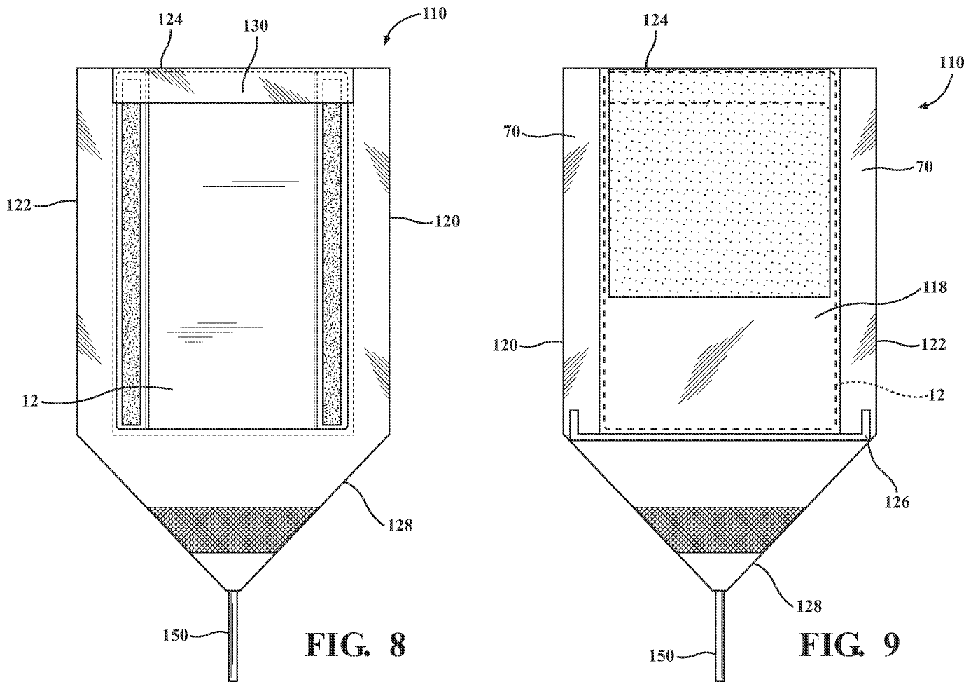

In FIGS. 8 and 9, a cover 110 constructed in accordance with another aspect of the disclosure is shown, wherein the same reference numerals, offset by a factor of 100, are used to identify like features. In discussion of the cover 110, focus is on those features that are different from features discussed above with regard to the cover 10, wherein the features not specifically discussed for the cover 110 can be provided as discussed for the cover 10, as will be readily understood by a POSA.

The cover 110 has a flexible upper wall 118 with opposite sides 120, 122 extending lengthwise between opposite ends, with one end being referred to as a proximal or first end 124, and the other end being referred to as a distal end or second end 126. A fluid collection funnel 128 extends from at least one of the ends, shown as extending from the second end 126, and at least one fixation member 130 extends adjacent at least one of the ends, shown as adjacent end 124, wherein the fixation member 130 is configured to releasably fix the flexible upper wall 118 directly to at least one of the compliant pad 12 and the patient support surface 14, as discussed above for the cover 10.

In lieu of the side flaps 62 and fluid barriers 64 discussed above for the cover 10, the cover 110 can be provided having a fluid collection channel 70 extending along each of the opposite sides 120, 122. The fluid collection channels 70 can be configured to channel fluid to the fluid collection funnel 128, thereby acting to prevent the flow of fluid over the side edges of the patient support surface 14, as discussed above for the fluid barriers 64. The fluid collection channels 70 can be formed of the same material used to form the upper wall 118, wherein the collection channels 70 can be formed as folded flaps of the upper wall material, thereby rendering the fluid collection channels 70 a monolithic piece of material with the upper wall 118. In essence, the fluid collection channels 70 serve as gutters, much like eaves troughs, to direct the flow of fluid to the fluid collection funnel 128. Accordingly, the cover 110 functions to contain and direct the flow of fluid, such as to and through a drain tube 150, as discussed above for the cover 10. Other than the fluid collection channels 70 discussed and illustrated, the cover 110 can be constructed in similar or the same fashion as discussed above for the cover 10, and thus, no further discussion is believed necessary.

In FIG. 11, a cover 210 constructed in accordance with another aspect of the disclosure is shown, wherein the same reference numerals, offset by a factor of 200, are used to identify like features. In discussion of the cover 210, focus is on those features that are different from features discussed above with regard to the cover 10, wherein the features not specifically discussed for the cover 210 can be provided as discussed for the cover 10, as will be readily understood by a POSA.

The cover 210 has a flexible upper wall 218 with opposite sides (not shown, but as discussed above, extending lengthwise between opposite ends, with one end, a distal end or second end 226 shown. The notable difference is with the mechanism for deploying the cover 210 about the accessory support housing 63 extending from each side of the patient table 16, such as shown in FIG. 11. Rather than tucking the cover 210 inwardly of the accessory support housings 63, as discussed above for cover 10, a tubular sleeve, also referred to as tubular wall 72, extends outwardly from each of a pair of openings 74 in the upper wall 218. The openings 74 and tubular walls 72 are configured for sliding receipt about the pair of accessory support housings 63 of the patient table. As such, receptacles 67 of the accessory support housing 63 remain fully accessible for receipt of attachment portions of the leg extension 65. Other than the openings 74 and tubular walls 72 discussed and illustrated, the cover 210 can be constructed in similar or the same fashion as discussed above for the cover 10, and thus, no further discussion is believed necessary.

In FIGS. 12A and 12B, a cover 310 constructed in accordance with another aspect of the disclosure is shown, wherein the same reference numerals, offset by a factor of 300, are used to identify like features. In discussion of the cover 310, focus is on those features that are different from features discussed above with regard to the cover 10, wherein the features not specifically discussed for the cover 310 can be provided as discussed for the cover 10, as will be readily understood by a POSA.

The cover 310 has a flexible upper wall 318 with opposite sides (not shown, but as discussed above, extending lengthwise between opposite ends, with one end, a distal end or second end 326 shown. The notable difference is with the mechanism for deploying the cover 310 about the accessory support housing 63 extending from each side of the patient table 16, such as shown in FIG. 12A. Rather than tucking the cover 310 inwardly of the accessory support housings 63, as discussed above for cover 10, a pair of openings 374 are provided adjacent the distal end 326. The pair of openings 374 are configured for alignment with the pair of accessory support housings 63 of the patient table 16 to facilitate releasable attachment of an auxiliary device to the patient table, such as the leg extension 65. A flexible flap 76 extends over each of the pair of openings 374. The flexible flaps 76 are moveable to close off the openings 374, thereby being able to protect against the ingress of fluid onto the accessory support housings 63 when not being use, and to expose the openings 374 when desired to gain access to the accessory support housings 63, such as when desired to affix the leg extension 65 thereto. Other than the openings 374 and the flaps 76 discussed and illustrated, the cover 310 can be constructed in similar or the same fashion as discussed above for the cover 10, and thus, no further discussion is believed necessary.

In accordance with another aspect of the disclosure, a method of protecting a compliant pad 12 on a patient support surface 14 of a patient table 16 and surroundings E of the patient support surface 14 against fluid contamination is provided. The method includes: providing a flexible upper wall 18, 118, 218, 318 having opposite sides 20, 22, 120, 122 extending lengthwise between opposite ends 24, 26, 124, 126 and having a fluid collection funnel 28, 128 extending from one of the opposite ends and at least one fixation member 30, 32, 130 extending adjacent at least one of the opposite ends; releasably and operably fixing the flexible upper wall 18, 118, 218, 318 to the compliant pad 12 with the at least one fixation member 30, 32, 130; and allowing the fluid collection funnel 28, 128 to hang over an edge of the patient support surface 14 to facilitate fluid flowing on the flexible upper wall 18, 118, 218, 318 to flow into the fluid collection funnel 28, 128.

In accordance with another aspect of the disclosure, the method can further include fixing the flexible upper wall 18, 118, 218, 318 directly to the compliant pad 12 with the at least one fixation member 30, 32, 130.

In accordance with another aspect of the disclosure, the method can further include disposing a first end of the compliant pad 12 into a first pocket 34 of the flexible upper wall 18, 118, 218, 318 and disposing a second end of the compliant pad into a second pocket 34 of the flexible upper wall 18, 118, 218, 318.

In accordance with another aspect of the disclosure, the method can further include providing the first and second pockets 34 being formed of the same type of material as the flexible upper wall 18, 118, 218, 318.

In accordance with another aspect of the disclosure, the method can further include coupling a drain tube 50 to a distal end 48 of the fluid collection funnel 28 to the direct the flow of fluid out of the fluid collection funnel 28.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A cover configured to protect a compliant pad for a patient support surface of a patient table to inhibit fluid contamination from contacting the compliant pad and the patient support surface, comprising:
a flexible upper wall having opposite sides extending lengthwise between opposite proximal and distal ends;
a fluid collection funnel extending from said distal end; and
at least one fixation member configured to releasably fix said flexible upper wall to at least one of the compliant pad and patient support surface.

2. The cover of claim 1, wherein said at least one fixation member is configured to attach said flexible upper wall directly to the compliant pad.

3. The cover of claim 2, wherein said at least one fixation member is formed from the same type of material as said flexible upper wall.

4. The cover of claim 2, wherein said at least one fixation member includes a first fixation member adjacent said proximal end and a second fixation member adjacent said distal end.

5. The cover of claim 4, wherein said first fixation member includes a first bottom wall extending beneath said upper wall to bound a first pocket, and wherein said second fixation member includes a second bottom wall extending beneath said upper wall to bound a second pocket, said first pocket having a first opening sized for receipt of one end of the compliant pad therein and said second pocket having a second opening sized for receipt of an opposite end of the compliant pad therein, said first and second openings facing one another.

6. The cover of claim 5, wherein said first bottom wall and said second bottom wall each have a plurality of openings configured to facilitate attachment of the compliant pad to the patient support surface.

7. The cover of claim 1, wherein said fluid collection funnel extends from a proximal end, fixed to said distal end of said flexible upper wall, to a free distal end, said fluid collection funnel being configured to channel fluid to a drain tube coupled to said distal end.

8. The cover of claim 7, wherein said fluid collection funnel has a fixation member extending along at least a portion of said proximal end, said fixation member being configured to releasably fix said proximal end to a funnel support member extending from the patient support surface and to maintain said proximal end in an open state to receive fluid therein.

9. The cover of claim 8, wherein said fixation member is formed from a folded cuff of material extending from said proximal end of the fluid collection funnel.

10. The cover of claim 1, further including a side flap extending outwardly from each of said opposite sides to inhibit fluid from flowing off the flexible upper wall.

11. The cover of claim 1, further including a pair of openings adjacent said distal end, said pair of openings being configured for alignment with a pair of accessory support housings of the patient table to facilitate releasable attachment of an auxiliary device to the patient table.

12. The cover of claim 11, further including a flexible flap extending over each of said pair of openings, said flexible flaps being moveable to close off said openings and to expose said openings.

13. The cover of claim 11, further including a tubular wall extending outwardly from each of said pair of openings, said tubular wall being configured for sliding receipt about the pair of accessory support housings of the patient table.

14. A method of protecting a compliant pad on a patient support surface and surroundings of the patient support surface against fluid contamination, comprising:
providing a flexible upper wall having opposite sides extending lengthwise between opposite ends and having a fluid collection funnel extending from one of the opposite ends and at least one fixation member extending adjacent at least one of the opposite ends;
releasably and operably fixing the flexible upper wall to the compliant pad with the at least one fixation member; and
allowing the fluid collection funnel to hang over an edge of the patient support surface to facilitate fluid flowing on the flexible upper wall to flow into the fluid collection funnel.

15. The method of claim 14, further including fixing the flexible upper wall directly to the compliant pad with the at least one fixation member.

16. The method of claim 15, further including disposing a first end of the compliant pad into a first pocket of the flexible upper wall and disposing a second end of the compliant pad into a second pocket of the flexible upper wall.

17. The method of claim 16, further including providing the first and second pockets being formed of the same type of material as the flexible upper wall.

18. The method of claim 14, further including coupling a drain tube to a distal end of the fluid collection funnel to the direct the flow of fluid out of the fluid collection funnel.

19. A cover and compliant pad assembly for a patient support surface, the cover inhibiting fluid contamination from contacting the compliant pad and the patient support surface, comprising:
a flexible upper wall having opposite sides extending lengthwise between opposite ends;
at least one fluid collection funnel extending from one of said opposite ends; and
at least one fixation member extending adjacent at least one of said ends, said at least one fixation member being configured to releasably fix said flexible upper wall to the compliant pad.

20. The assembly of claim 19, wherein said at least one fixation member includes a first pocket adjacent one of said opposite ends and a second pocket adjacent the other of said opposite ends, said first and second pockets being sized for receipt of opposite ends of the compliant pad therein.
